(19) United States
(12) Patent Application Publication
(10) Pub. No.: US 2025/0309348 A1
(43) Pub. Date: Oct. 2, 2025

(54) ELECTROLYTIC SOLUTION FOR LITHIUM METAL BATTERY

(71) Applicant: HONDA MOTOR CO., LTD., Tokyo (JP)

(72) Inventors: Takeshi FUJINO, Saitama (JP); Taku IMAIZUMI, Saitama (JP)

(21) Appl. No.: 19/058,029

(22) Filed: Feb. 20, 2025

(30) Foreign Application Priority Data
Mar. 28, 2024 (JP) 2024-054139

(51) Int. Cl. H01M 10/0567; H01M 10/052; H01M 10/0568; H01M 10/0569

(52) U.S. Cl. CPC H01M 10/0567; H01M 10/052; H01M 10/0568; H01M 10/0569; H01M 2300/0034; H01M 2300/0037

(57) ABSTRACT

An electrolytic solution for a lithium metal battery, including an electrolyte salt and an organic solvent, the electrolyte salt including lithium bis-fluorosulfonylimide (LiFSI); the organic solvent including 1,2-dimethoxyethane (DME) and 1,1,2,2-tetrafluoroethyl-2,2,3,3-tetrafluoropropyl ether (TTE); the electrolytic solution further including a first compound that is a polyethylene glycol compound having an average molecular weight of 200 to 1200 and that is included in the electrolytic solution for a lithium metal battery at 0.015% by mass or more and less than 0.3% by mass, and a second compound that is at least one selected from the group consisting of diglyme, triglyme, and tetraglyme and that is included in the electrolytic solution for a lithium metal battery at 0.1% by mass or more and less than 1.0% by mass.

This application is based on and claims the benefit of priority from Japanese Patent Application No. 2024-054139, filed on 28 Mar. 2024, the content of which is incorporated herein by reference.

### BACKGROUND OF THE INVENTION

### Field of the Invention

The present invention relates to an electrolytic solution for a lithium metal battery.

### Related Art

In recent years, to ensure that more people have access to affordable, reliable, sustainable, and advanced energy, research and development has been carried out on secondary batteries, which contribute to energy efficiency. Among the secondary batteries, lithium metal batteries, which use a lithium metal as the negative electrode, are attracting attention.

The lithium metal batteries may suffer from deterioration of battery performance as lithium is deposited on the negative electrode with charge and discharge cycles, forming dendrites and becoming porous. As a technology for suppressing the above dendrites, it has been known that an organic or inorganic coating is applied to the surfaces of the negative electrode and separator (e.g., Patent Document 1).
Patent Document 1: Japanese Unexamined Patent Application (Translation of PCT Application), Publication No. 2020-532077

### SUMMARY OF THE INVENTION

The technology disclosed in Patent Document 1 relates to a lithium electrode containing an olefin-based ion-conductive polymer as a protective layer formed on at least one side of a lithium metal layer. According to the above technology, it is known that the formation and growth of lithium dendrites can be minimized. On the other hand, it is difficult to form the above protective layer on a thin lithium negative electrode or to form a similar protective layer on a separator, and problems are difficulty in quality control in the process and increased production costs. Another problem is that the protective layer increases the battery resistance. Not only polymers, but also various additives of inorganic Li salts are known, but some additives for protecting Li are added, and the more components there are, the more the solubility of added substances decreases, and the added substances deposit, causing the solution to become cloudy. In addition, increasing the nickel ratio of the positive electrode active materials can improve the energy density of the battery, but to suppress positive electrode degradation and gas generation, positive electrode additives are required. The problem is that the more additive components there are, the higher the viscosity of the electrolytic solution becomes, which makes it more difficult for the Li ions to diffuse, and in turn reduces the battery's output and durability, to be the problem that makes it very difficult to find a balance.

The present invention has been made in view of the above problems and aims to provide an electrolytic solution for a lithium metal battery which can easily improve the durability of the lithium metal battery as well as suppress the increase of the battery resistance.

A first aspect of the present invention relates to an electrolytic solution for a lithium metal battery, including an electrolyte salt and an organic solvent, the electrolyte salt including lithium bis-fluorosulfonylimide (LiFSI); the organic solvent including 1,2-dimethoxyethane (DME) and 1,1,2,2-tetrafluoroethyl-2,2,3,3-tetrafluoropropyl ether (TTE), the electrolytic solution further including a first compound that is a polyethylene glycol compound having an average molecular weight of 250 to 1000 and a second compound that is at least one selected from the group consisting of diglyme, triglyme, and tetraglyme, the first compound being included in the electrolytic solution for a lithium metal battery at 0.015% by mass or more and less than 0.3% by mass; the second compound being included in the electrolytic solution for a lithium metal battery at 0.1% by mass or more and less than 0.3% by mass.

According to the invention of the first aspect, it is possible to provide an electrolytic solution for a lithium metal battery which can easily improve durability of the lithium metal battery as well as which can suppress an increase in the battery resistance.

A second aspect of the present invention relates to the electrolytic solution for a lithium metal battery as described in the first aspect, in which a concentration of the lithium bis-fluorosulfonylimide (LiFSI) as the electrolyte salt in the electrolytic solution for a lithium metal battery is 1.5 mol/L or more and 2.5 mol/L or less.

According to the invention of the second aspect, it is possible to easily improve durability of the lithium metal battery even when the electrolytic solution has a high concentration, as well as it is possible to suppress an increase in the battery resistance.

A third aspect of the present invention relates to the electrolytic solution for a lithium metal battery as described in the first or second aspect, in which a molar ratio, DME/LiFSI, of the 1,2-dimethoxyethane (DME) as the organic solvent with respect to the lithium bis-fluorosulfonylimide (LiFSI) as the electrolyte salt is 1.5 to 2.3, and a mass proportion of the 1,1,2,2-tetrafluoroethyl-2,2,3,3-tetrafluoropropyl ether (TTE) as the organic solvent with respect to a total amount of the lithium bis-fluorosulfonylimide (LiFSI) and the 1,2-dimethoxyethane (DME) is 40% by mass or more and 60% by mass or less.

According to the invention of the third aspect, even if an amount of TTE, a non-polar solvent, is increased above a certain level, that is, even if a relative amount of DME decreases, the electrolytic solution of the present invention is capable of dissolving a plurality of inorganic additives and a plurality of organic additives, and thus it is possible to suppress deposition of LiFSI and inorganic additives.

A fourth aspect of the present invention relates to the electrolytic solution for a lithium metal battery as described in any one of the first to third aspects, in which the first compound is represented by formula (1) below:

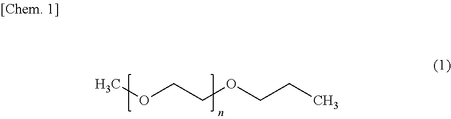

wherein n represents an integer of 5 to 20.

According to the invention of the fourth aspect, the durability of the lithium metal battery can be preferably improved by a thin film formed on the surface of the negative electrode by the first compound.

A fifth aspect of the present invention relates to the electrolytic solution for a lithium metal battery as described in the fourth aspect, in which n=6 in the formula (1).

According to the invention of the fifth aspect, the durability of the lithium metal battery can be preferably improved by the thin film formed on the surface of the lithium metal negative electrode by the first compound.

A sixth aspect of the present invention relates to the electrolytic solution for a lithium metal battery as described in any one of the first to fifth aspect, in which the second compound is diglyme or triglyme.

According to the invention of the sixth aspect, the durability of the lithium metal battery can be preferably improved because an amount of lithium eluted during charging and discharging is controlled by the second compound.

A seventh aspect of the present invention relates to the electrolytic solution for a lithium metal battery as described in any one of the first to sixth aspects, further including a difluoro(oxalato)borate (FOB) anion and a calcium (Ca) cation.

According to the invention of the seventh aspect, even when the electrolytic solution of the present invention has a fluorinated ether ratio of about 50%, the solubility of additives to an electrolytic solution having a high concentration is high, and thus synergistic effects, such as suppression of a decrease in a capacity retention ratio of the battery, are preferably obtained, depending upon the type of additives.

### DETAILED DESCRIPTION OF THE INVENTION

### <Electrolytic Solution for Lithium Metal Battery>

An electrolytic solution for a lithium metal battery according to the present embodiments comprises an electrolyte salt, an organic solvent, a first compound, and a second compound.

As the electrolyte salt, lithium bis-fluorosulfonylimide (LiFSI) is included as an essential component. Lithium salts other than LiFSI may be included as the electrolyte salt. Examples of the lithium salts include LiPF₆, LiBF₄, LiClO₄, LiAsF₆, LiCF₃SO₃, LiC(CF₃SO₂)₃, LiN(CF₃SO₂)₂(LiTFSI), and LiBC₄O₈. These can be used singly or in combinations of two or more thereof. It is preferable that only LiFSI is included as the electrolyte salt.

A concentration of LiFSI as the electrolyte salt in the electrolytic solution for a lithium metal battery is preferably about 2.0 mol/L, more preferably 1.5 mol/L or more and 2.5 mol/L or less. In the electrolytic solution for a lithium metal battery according to the present embodiments, a thin film can be formed on a negative electrode without adding a polymer in the electrolytic solution, and thus the increase in viscosity of the electrolytic solution can be suppressed. Therefore, even if the concentration of electrolyte salts or the concentration of inorganic compound additives is increased, the decrease in the discharge output and charging performance of the lithium metal battery due to the increase in the viscosity of the electrolytic solution is suppressed. The above concentration of LiFSI may be 1.0 mol/L or more and 2.6 mol/L or less.

The viscosity of the electrolytic solution for a lithium metal battery according to the present embodiments is preferably in a range of 5 mPa-s to 12 mPa-s.

The organic solvent mainly includes a linear ether and a linear fluorinated ether. Specifically, 1,2-dimethoxyethane (DME) and 1,1,2,2-tetrafluoroethyl-2,2,3,3-tetrafluoropropyl ether (TTE) are essential. Organic solvents other than those described above may be included. Examples of the linear ether include 1,2-diethoxyethane, diethyl ether, and 1-ethoxy-2-(2-methoxyethoxy)ethane.

Examples of the linear fluorinated ether include compounds represented by formula (2) below:

R¹—O—R² (2). In the formula (2), R¹ and R² each independently represent a fluorinated hydrocarbon group such as a fluorinated alkyl group. The number of carbon atoms in R¹ and R² is not limited, and may be, for example, 1 to 8. Examples include 1,1,2,2-tetrafluoroethyl-2,2,2-trifluoroethyl ether.

In the present embodiments, the linear ethers and the linear fluorinated ethers described above can be used singly or in combinations of two or more thereof. In addition, organic solvents other than the linear ether and the linear fluorinated ether may be included. Examples include ethylene carbonate (EC), propylene carbonate (PC), sulfolane (SL), dimethyl carbonate (DMC), diethyl carbonate (DEC), and ethyl methyl carbonate (EMC). These organic solvents other than the linear ethers and the linear fluorinated ethers can be used singly or in combinations of two or more thereof. These organic solvents, other than the linear ether and the linear fluorinated ether, may be included in a proportion of 50% by mol or less with respect to the total amount of the linear ether and the linear fluorinated ether.

As the organic solvent, it is preferable that only 1,2-dimethoxyethane (DME) and 1,1,2,2-tetrafluoroethyl-2,2,3,3-tetrafluoropropyl ether (TTE) are included. In this case, a molar ratio of the 1,2-dimethoxyethane (DME) as the organic solvent with respect to the lithium bis-fluorosulfonylimide (LiFSI) as the electrolyte salt, DME/LiFSI, is preferably 1.5 to 2.3. In addition, a mass proportion of the 1,1,2,2-tetrafluoroethyl-2,2,3,3-tetrafluoropropyl ether (TTE) as the organic solvent with respect to the total amount (LiFSI+DME) of the lithium bis-fluorosulfonylimide (LiFSI) and the 1,2-dimethoxyethane (DME), (TTE/(LiFSI+DME)), is preferably 40% by mass or more and 60% by mass or less.

The first compound is a component that forms a thin film on the negative electrode. By including the first compound in the electrolytic solution for a lithium metal battery, a thin film layer of about 1 μm in thickness can be formed between the negative electrode of the lithium metal battery (lithium metal layer) and the lithium metal deposited on the negative electrode. The above thin film suppresses the formation of dendrites and improves the durability of the lithium metal battery.

The first compound is a polyethylene glycol compound having an average molecular weight of 250 to 1000. In the present specification and the scope of claims, the polyethylene glycol compound is a compound obtained by polymerizing ethylene oxides, and includes those having a linear or branched structure. The polyethylene glycol compound may optionally have a substituent group with polarity. The above substituent group is not limited, and examples include a hydroxyl group, a carboxyl group, a thiol group, and a nitrile group. In the above alkyl group, a linear alkyl group and a branched alkyl group are included. Different types of compounds can be used in combination as the first compound.

The first compound is, for example, the compound represented by formula (2) below.

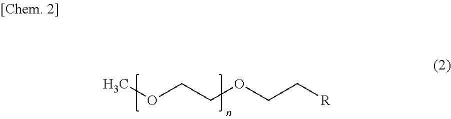

In the above formula (2), n represents an integer, and R represents an arbitrary substituent group.

The first compound is preferably a compound represented by formula (1) below.

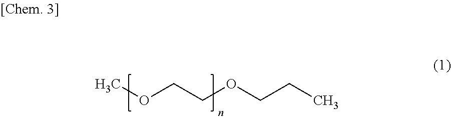

In the above formula (1), n represents an integer of 5 to 20. In the above formula (1), n=6 is preferable.

The first compound is included in the electrolytic solution for a lithium metal battery at 0.015% by mass or more and less than 0.3% by mass. The content of the above first compound is preferably 0.015% by mass or more and less than 0.1% by mass.

The second compound has the function of adjusting the amount of lithium eluted from the lithium metal negative electrode during charging and discharging. The above function of the second compound can make it to improve the durability of the lithium metal battery.

The second compound is at least one selected from the group consisting of diglyme (diethylene glycol dimethyl ether), triglyme (triethylene glycol dimethyl ether), and tetraglyme (tetraethylene glycol dimethyl ether). These can be used singly or in combinations of two or more thereof. The second compound is preferably the tetraglyme.

The second compound is included in the electrolytic solution for a lithium metal battery at 0.1% by mass or more and less than 1.0% by mass. The content of the above second compound is preferably 0.05% by mass or more and less than 0.25% by mass.

Substances other than those described above may be included in the electrolytic solution for a lithium metal battery according to the present embodiments. For example, it is preferable that additives may be included. As the additives, the inorganic oxides of alkali metals can be used. Through the synergistic effects of the inorganic oxides of alkali metals and the above organic solvents, the lithium metal battery having a high capacity retention ratio can be obtained.

In the electrolytic solution for a lithium metal battery according to the present embodiments, a FOB (difluoro(oxalato)borate) anion and a Ca (calcium) cation are preferably included as additives. This can remove residual moisture and stabilize Li deposition. Examples of the supply sources of the FOB (difluoro(oxalato)borate) anion include LiFOB and Ca(FOB)₂. An amount of the above additives added in the electrolytic solution is preferably 0.1 wt % to 2 wt %. Examples of the supply sources of the Ca(calcium) cation include Ca(TFSI)₂, Ca(FSI)₂, and Ca(BF₄)₂. When LiFOB (lithium difluoro(oxalato)borate) is used as the additive, the content in the electrolytic solution is preferably 0.1 wt % to 2 wt %. In addition to the above additives, known components used for the electrolytic solution for a lithium metal battery may be included as additives. Examples include film forming materials and dispersants. Specifically, the following may be included: Mg(FSI)₂, Mg(TFSI)₂, Ba(FSI)₂, Ba(TFSI)₂, Zn(FSI)₂, Zn(TFSI)₂, LiTFSI, LiNO₃, lithium nitrite, LiPO₂F2, CsPF₆, lithium sulfate, etc., as alkali metal salts; propane sultone, ethylene sulfite, etc., as organic additives; and acetonitrile, adiponitrile, butyronitrile, diphenyl sulfide, etc., as nitrile-based compounds.

### <Lithium Metal Battery>

The electrolytic solution according to the present embodiments constitutes a lithium metal battery. The specific configuration of the lithium metal battery is not limited except for the electrolytic solution, configurations used for known lithium metal batteries can be used without limitation. As a typical aspect, the lithium metal battery includes a positive electrode layer, a negative electrode layer, and an electrolyte layer disposed between the positive electrode layer and the negative electrode layer, the electrolyte layer including the electrolytic solution according to the present embodiments.

The positive electrode layer is a layer containing a positive electrode active material. The positive electrode active material is not limited if it can be a material that can be used as the positive electrode active material of the lithium metal battery. Examples of the positive electrode active material include a layered active material, a spinel type active material, and an olivine type active material, containing lithium. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganese oxide (LiMn₂O₄), and heteroatom-substituted Li—Mn spinel represented by Li₁+xMn₂-x-yMyO₄ (x+y=2, M=at least one selected from the group consisting of Al, Mg, Co, Fe, Ni, and Zn), lithium titanate (an oxide containing Li and Ti), and lithium metal phosphate (LiMPO₄, M=at least one selected from the group consisting of Fe, Mn, Co, and Ni). In addition to the positive electrode active material, the positive electrode layer may contain a binder, a conductive aid, and the like. In addition, a positive electrode current collector may be disposed adjacent to the positive electrode layer. The positive electrode current collector is not limited, as long as it is a material that can be used as a positive electrode current collector of the lithium metal battery.

The negative electrode layer is a layer containing a negative electrode active material. As the negative electrode active material, lithium metal or lithium alloy, for example, can be used alone or in combination. Examples of the element that can form an alloy with lithium metal include Al, Mg, K, Na, Ca, Sr, Ba, Si, Ge, Sb, Pb, Sn, In, and Zn. In addition to those described above, a composite may be used in which carbon or an organic substance is incorporated into lithium metal. In addition, a negative electrode current collector may be disposed adjacent to the negative electrode layer. The negative electrode current collector is not limited, as long as it is a material that can be used as the negative electrode current collector of the lithium metal battery.

The electrolyte layer includes an electrolytic solution according to the above embodiments. The electrolyte layer may be composed of a separator in which the electrolytic solution is impregnated and which prevents a short circuit between the positive electrode and the negative electrode. As the separator, known materials for separators in lithium metal batteries, such as non-woven fabric or a microporous film, can be used.

The foregoing is an explanation of the preferable embodiments of the present invention, but the present invention is not limited to the above embodiments, and any variation or improvement within the scope of the present invention that will achieve the purpose of the present invention is included in the present invention.

### Examples

Hereinafter, the present invention will be described in detail with reference to Examples. However, the present invention is not limited to these Examples.

### [Preparation of Electrolytic Solution for Lithium Metal Battery]

The electrolytic solution for a lithium metal battery with respect to each Example and Comparative Example was prepared using the mixture shown in Table 1 and Table 2 below.

TABLE 1

| | | Example | | | | | | | Comparative Example | | |
|---|---|---|---|---|---|---|---|---|---|---|---|
| | Unit | 1 | 2 | 3 | 4 | 5 | 6 | 7 | 1 | 2 | 3 |
| LiFSI | mol/L | 2.35 | 2.35 | 2.35 | 2.35 | 2.35 | 2.35 | 2.35 | 2.35 | 2.35 | 2.35 |
| DME | Molar ratio | 65 | 65 | 65 | 65 | 65 | 65 | 65 | 65 | 65 | 65 |
| TTE | Molar ratio | 35 | 35 | 35 | 35 | 35 | 35 | 35 | 35 | 35 | 35 |
| First | Name | PEG350 | PEG350 | PEG350 | PEG350 | PEG350 | PEG350 | PEG350 | — | — | — |
| compound | Molecular weight | 350 | 350 | 350 | 350 | 350 | 350 | 350 | — | — | — |
| | n in formula (1) | n = 6 | n = 6 | n = 6 | n = 6 | n = 6 | n = 6 | n = 6 | — | — | — |
| | Content (% by mass) | 0.05 | 0.02 | 0.05 | 0.02 | 0.02 | 0.05 | 0.02 | — | — | — |
| Second | Name | G2 | G2 | G3 | G3 | G3 | G4 | G4 | — | G3 | G4 |
| compound | Content (% by mass) | 0.10 | 0.10 | 0.10 | 0.10 | 0.20 | 0.10 | 0.20 | — | 0.50 | 0.50 |
| Additives | LiFOB (% by mass) | 1.0 | 1.0 | 1.0 | 1.0 | 1.0 | 1.0 | 1.0 | 1.0 | 1.0 | 1.0 |
| | CaFSI (% by mass) | 0.5 | 0.5 | 0.5 | 0.5 | 0.5 | 0.5 | 0.5 | 0.5 | 0.5 | 0.5 |
| Capacity | % | 97.24 | 97.04 | 96.56 | 96.56 | 98.02 | 96.56 | 96.75 | 87.80 | 87.80 | 89.58 |
| retention | | | | | | | | | | | |
| ratio | | | | | | | | | | | |
| BOL | Ω · cm² | 22.6 | 22.6 | 22.5 | 22.5 | 22.3 | 24.5 | 23.9 | 20.4 | 23.1 | 23.6 |
| specific | | | | | | | | | | | |
| resistance | | | | | | | | | | | |

TABLE 2

| | | Comparative Example | | | | | | | | |
|---|---|---|---|---|---|---|---|---|---|---|
| | Unit | 4 | 5 | 6 | 7 | 8 | 9 | 10 | 11 | 12 |
| LiFSI | mol/L | 2.35 | 2.35 | 2.35 | 2.35 | 2.35 | 2.35 | 2.35 | 2.35 | 2.35 |
| DME | Molar ratio | 65 | 65 | 65 | 65 | 65 | 65 | 65 | 65 | 65 |
| TTE | Molar ratio | 35 | 35 | 35 | 35 | 35 | 35 | 35 | 35 | 35 |
| First | Name | PEG2000 | PEG2000 | PEG250 | PEG250 | PEG350 | PEG350 | PEG350 | PEG350 | PEG350 |
| compound | Molecular weight | 2000 | 2000 | 250 | 250 | 350 | 350 | 350 | 350 | 350 |
| | n in formula (1) | n = 40 | n = 40 | n = 5 | n = 5 | n = 6 | n = 6 | n = 6 | n = 6 | n = 6 |
| | Content (% by mass) | 0.20 | 0.05 | 0.20 | 0.01 | 0.01 | 0.05 | 0.05 | 0.05 | 0.05 |
| Second | Name | — | — | — | — | — | G4 | G4 | G3 | G2 |
| compound | Content (% by mass) | — | — | — | — | — | 0.50 | 0.05 | 0.50 | 0.50 |
| Additives | LiFOB (% by mass) | 1.0 | 1.0 | 1.0 | 1.0 | 1.0 | 1.0 | 1.0 | 1.0 | 1.0 |
| | CaFSI (% by mass) | 0.5 | 0.5 | 0.5 | 0.5 | 0.5 | 0.5 | 0.5 | 0.5 | 0.5 |
| Capacity | % | 87.80 | 89.58 | 86.93 | 87.80 | 88.69 | 93.24 | 93.24 | 92.31 | 92.31 |
| retention | | | | | | | | | | |
| ratio | | | | | | | | | | |
| BOL | Ω · cm² | 29.3 | 25.6 | 24.8 | 22.0 | 22.2 | 23.3 | 23.3 | 23.3 | 21.5 |
| specific | | | | | | | | | | |
| resistance | | | | | | | | | | |

In Table 1 and Table 2, “PEG350” denotes polyethylene glycol having an average molecular weight of 350, and “PEG2000” denotes polyethylene glycol having an average molecular weight of 2000. In addition, “G2” denotes diglyme, “G3” denotes triglyme, and “G4” denotes tetraglyme. “Content (% by mass)” indicates the content in the electrolytic solution for a lithium metal battery. “Molar ratio” of DME and TTE indicates the molar ratio with respect to the total amount of DME and TTE.

### [Production of Test Cells]

Using the electrolytic solution with respect to each of Example and Comparative Example described above, test cells were produced according to the procedure shown below.

### (Production of Positive Electrode)

2 wt % of acetylene black (AB) as an electron-conductive material, 1.5 wt % of polyvinylidene fluoride (PVDF) as a binder, and polyvinylpyrrolidone (PVP) as a dispersant were pre-mixed in N-methyl-2-pyrrolidone (NMP) as a dispersion solvent, and then wet-mixed using a rotating and revolving mixer, to obtain a pre-mixed slurry. Then, LiNi_{0.8}Co_{0.1}Mn_{0.1}O₂ (NCM811) as the positive electrode active material and a pre-doping material, and the obtained pre-mixed slurry were mixed and subjected to a dispersion treatment using a planetary mixer, to obtain a positive electrode paste. NCM811 has a median diameter of 4 μm. Next, the positive electrode paste obtained was applied to the positive electrode current collector made of aluminum without a primer layer, dried, and pressed using a roller press, to obtain a positive electrode having an electrode mix layer of 64 μm in thickness and a density of 3.3 g/cm³. It was then dried in vacuum at 120° C., to form a positive electrode plate having the positive electrode mix layer. The resulting positive electrode plate was punched out to a size of 30 mm×40 mm, to serve as the positive electrode.

### (Preparation of Negative Electrode)

As a negative electrode, a clad material of copper foil of 10 μm in thickness and lithium foil of 20 μm in thickness was used. It was punched out so that an electrode area was a size of 34 mm×44 mm, to serve as the negative electrode.

### (Preparation of Separator)

As a separator, used was an alumina coated polyethylene microporous membrane. As the electrolytic solution, used was each shown in Table 1.

### (Production of Lithium Metal Battery)

After placing the positive electrode—the separator—the negative electrode in a container made by heat-sealing an aluminum laminate for secondary batteries (produced by Dai Nippon Printing Co., Ltd.) to form it into a bag shape, 350 μl of an electrolytic solution was poured in, and then left at 45° C. for 5 hours, and then charged and discharged twice at 0.1 C (4.3 V to 2.65 V) to produce a lithium metal battery.

### [Measurement of Capacity Retention Ratio]

Using the test cell produced by using the electrolytic solution with respect to each Example and Comparative Example described above, the capacity retention ratio was measured. CCCV charging was performed at 25° C. to 4.3 V by using a 0.33 C (1/3 C) charge during charging and discharging, and then CV charging was performed for 20 minutes. After standing for 10 minutes, the battery was discharged to 2.65 V by using 0.33 C. This was taken as 100% battery capacity.

### [Measurement of BOL Specific Resistance]

Using the test cell produced using the electrolytic solution with respect to each Example and Comparative Example described above, a BOL specific resistance was measured. Specifically, the SOC was set at 50% by charging the cell to 50% of the discharge capacity at the initial capacity measurement. From this voltage, 4.5 C discharge was performed for 10 seconds, to calculate a resistance value. This resistance value was divided by the electrode area of the positive electrode, 12 cm², to calculate the specific resistance, Ω·cm². The results are shown in Table 1 and Table 2.

### [Evaluation of Capacity Retention Ratio]

In a thermostatic chamber at 25° C., a charge and discharge cycle of 4.3 V to 2.65 V was performed 99 times under the following conditions: an upper limit voltage: 4.3 V, a charge: 0.33 C, a lower limit voltage: 2.65 V, a discharge: 0.33 C, and after the discharge, the battery was left to stand for 6 hours, to perform the 100^{th} measurement of the rating capacity, to calculate the capacity retention ratio.

As shown in Table 1 and Table 2, in the test cell produced by using the electrolytic solution with respect to each Example, better capacity retention ratios were obtained compared to Comparative Examples. It is also evident that a predetermined range of molecular weights of the first compound can reduce the battery resistance value.

What is claimed is:

1. An electrolytic solution for a lithium metal battery, comprising an electrolyte salt and an organic solvent,
the electrolyte salt comprising lithium bis-fluorosulfonylimide (LiFSI);
the organic solvent comprising 1,2-dimethoxyethane (DME) and 1,1,2,2-tetrafluoroethyl-2,2,3,3-tetrafluoropropyl ether (TTE),
the electrolytic solution further comprising a first compound that is a polyethylene glycol compound having an average molecular weight of 250 to 1200 and a second compound that is at least one selected from the group consisting of diglyme, triglyme, and tetraglyme,
the first compound being included in the electrolytic solution for a lithium metal battery at 0.015% by mass or more and less than 0.3% by mass;
the second compound being included in the electrolytic solution for a lithium metal battery at 0.05% by mass or more and less than 0.3% by mass.

2. The electrolytic solution for a lithium metal battery according to claim 1, wherein a concentration of the lithium bis-fluorosulfonylimide (LiFSI) as the electrolyte salt in the electrolytic solution for a lithium metal battery is 1.5 mol/L or more and 2.5 mol/L or less.

3. The electrolytic solution for a lithium metal battery according to claim 1,
wherein a molar ratio DME/LiFSI of the 1,2-dimethoxyethane (DME) as the organic solvent with respect to the lithium bis-fluorosulfonylimide (LiFSI) as the electrolyte salt is 1.5 to 2.3, and
a mass proportion of the 1,1,2,2-tetrafluoroethyl-2,2,3,3-tetrafluoropropyl ether (TTE) as the organic solvent with respect to a total amount of the lithium bis-fluorosulfonylimide (LiFSI) and the 1,2-dimethoxyethane (DME) is 40% by mass or more and 60% by mass or less.

4. The electrolytic solution for a lithium metal battery according to claim 1, wherein the first compound is represented by formula (1) below: 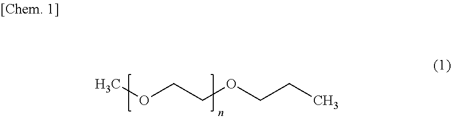
wherein n represents an integer of 5 to 20.

5. The electrolytic solution for a lithium metal battery according to claim 4, wherein n=6 in the formula (1).

6. The electrolytic solution for a lithium metal battery according to claim 1, wherein the second compound is diglyme or triglyme.

7. The electrolytic solution for a lithium metal battery according to claim 1, further comprising a difluoro(oxalato)borate (FOB) anion and a calcium (Ca) cation.
